(19) United States
(12) Patent Application Publication
(10) Pub. No.: US 2002/0181805 A1
(43) Pub. Date: Dec. 5, 2002

(54) Apparatus and methods for image scanning of variable sized documents having variable orientations

(76) Inventors: Helen S. Loeb, Wynnewood, PA (US); Steven Robert Wilcox, Marlton, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/140,632

(22) Filed: May 7, 2002

Related U.S. Application Data
(63) Continuation-in-part of application No. 09/497,896, filed on Feb. 4, 2000.
(60) Provisional application No. 60/140,507, filed on Jun. 22, 1999.

(51) Int. Cl. G06K 9/20

(52) U.S. Cl. 382/317

(57) ABSTRACT

Apparatus and methods for image scanning of variable sized documents having variable orientations are disclosed. Apparatus for scanning a slip includes a slip editor that provides a user interface via which slip definition parameters that define a slip to be scanned can be entered. The slip editor receives the slip definition parameters via the user interface, and stores the received slip definition parameters in a slip definition parameter file.

### RELATED APPLICATIONS

This application is a continuation-in-part of co-pending U.S. patent application Ser. No. 09/497,896, filed Feb. 4, 2000, which claims priority from Provisional U.S. Patent Application No. 60/140,507, filed Jun. 22, 1999, the contents of each of which are hereby incorporated by reference.

### FIELD OF THE INVENTION

This invention relates to scanning devices. More particularly, the invention relates to a scanner that automatically transports, scans, and transmits mark-sense, character, bar-code, and image data from documents of varying sizes, regardless of their orientation.

### BACKGROUND OF THE INVENTION

Forms for recording handwritten marks for entry of data into a data processing system generally have a plurality of discrete areas arranged in a pattern delineated by background printing on the form. The user indicates a choice by placing a mark in one of a series of areas presented for choice. Each of the areas is typically defined by a box, oval, pair of spaced lines, etc., and the form normally has a field for a number of such choices. Forms of this type are used, for example, to encode a lottery player's choice of numbers for a wager, using a form reader, or scanner, that is in data communication with a host processing system, such as a lottery agent terminal and/or central lottery computer.

Upon validation of a player's entry, the lottery agent terminal prints an entry ticket showing the player's entry, along with a serial number or other unique identification. The unique identification can include printed alphanumeric characters, bar code data, optical character recognition (OCR) characters, and/or darkened blocks in a geometric pattern representing numeric data. If the player presents a printed ticket as a winning ticket, the lottery agent enters data from the ticket into the terminal for verification by the lottery central computer over the data communication link. These data can be read automatically in the same manner as a handwritten entry form, using an appropriate scanner.

In many cases, validation of winning tickets was performed manually, although there were significant accounting and ticket handling burdens for the selling agents and the systems were prone to clerical errors. In addition, there were potential problems with illegal activities including cashing of altered tickets, theft of paid tickets from the selling establishments, the cashing of stolen tickets, etc.

Accordingly, computerized cashing apparatus was developed so that tickets could be validated by a central computer. In this scheme, each ticket selling establishment has a remote computer terminal connected to the central computer. In addition to the regular information described above, a computer-readable code was printed on the lottery tickets, which code identified each ticket uniquely to the computer. Usually, this code was in a mark-sense format, and scanners with discrete sensor locations were contained within the remote terminal and used to read the mark-sense code. The information in the code was then forwarded to the central computer for validation.

The scanners used in these systems typically scan the tickets and forward the raw data to the host computer. Usually mark-sense data is sent, although signature, character, or bar-code data might be sent in more advanced systems. The host computer then processes the raw data, and presents the information in a readable format to the user via the host terminal.

Scanning systems such as those described above typically require that the user insert the ticket or other document to be scanned into the scanner in a “proper” orientation. In this way, the scanning system can locate certain data on the document that has been received to identify the document type, and to extract meaningful data therefrom. Form scanning would be less time consuming and less distracting to the user, however, if the user did not have to “properly” orient the form prior to insertion. Consequently, it would be advantageous to such users if a scanning system were provided that allowed the user to insert the document into the scanning system in any orientation.

Thus, there is a need in the art for an optical scanning system that accurately processes documents that include combinations of mark-sense data, image data, character (OCR) data, and bar-code (BCR) data, regardless of the orientation of the document as it is inserted into the scanner, and regardless of the multiplicity and location of the combinations of mark-sense, image, OCR, and BCR data fields on the form.

### SUMMARY OF THE INVENTION

The present invention satisfies these needs in the art by providing apparatus and methods for image scanning of variable sized documents having variable orientations. A method for processing a scanned image of a document includes receiving a data set representative of a bit map image of a scanned document. Preferably, the bit map image is produced by a scanner.

First, the bit map image is aligned based on a rotational indicator obtained from the data set. Aligning the bit map image can include determining a location of the rotational indicator on the document, and defining an origin on the document based on the location of the alignment indicator. Similarly, a document type can be determined based on a document type indicator obtained from the data set.

A document can include up to 16 data areas, each of which includes mark-sense data, image data, character data, and bar code data, depending on the document type. Data is extracted from the aligned bit map image based on a predefined document mask associated with the document type.

Apparatus for scanning a document includes a scanner and a host processor coupled to the scanner. The scanner receives a document having at least one data area, scans the document to generate a bit map image of the document, and forwards a data set representative of the bit map image of the document to the host processor. The host processor receives the data set, aligns the bit map image based on a rotational indicator obtained from the data set, determines a document type based on a document type indicator obtained from the data set, and processes the data area based on the document type. A slip editor can be provided to allow a user to generate a document mask that defines a slip to be scanned.

The scanner can include a photosensor array having a plurality of light sensitive elements, and can be calibrated by the following method. First, a calibration plaque having a known reflectivity is scanned, and a calibration intensity value for each light sensitive element is determined. The calibration intensity value represents the intensity of light received by the light sensitive element while the calibration plaque is being scanned. A sensitivity threshold is then defined for each light sensitive element to have a value based on the calibration intensity value determined for the light sensitive element.

The scanner can also include a thermal document brand head that is connected to the host processor. The host processor can then download print information, such as bitmap data, to the thermal brand head for printing onto a document in the scanner.

A method according to the invention for defining a slip to be scanned includes providing a user interface via which slip definition parameters that define the slip can be entered. The slip definition parameters can include one or more of a slip name, a slip identification number, a slip width, and a slip length. The slip can have a variable slip width and a variable slip length. The slip definition parameters can also include a data area definition parameter that defines one or more data areas on the slip. A data type parameter can be received that identifies a respective data type associated with each such data area. The data type can be bar code data, image data, mark-sense data (with or without clocks), and optical character recognition data. The data area definition parameter can include a data area location parameter that identifies a location of the data area on the slip. The slip definition parameters are stored in a slip definition parameter file.

### BRIEF DESCRIPTIONS OF THE DRAWINGS

The foregoing summary, as well as the following detailed description of the preferred embodiments, is better understood when read in conjunction with the appended drawings. For the purpose of illustrating the invention, there is shown in the drawings an embodiment that is presently preferred, it being understood, however, that the invention is not limited to the specific methods and instrumentalities disclosed.

FIG. 1 is an isometric view of a preferred embodiment of a scanner according to the present invention.

FIGS. 2A and 2B are side views of the scanner of FIG. 1 in open and closed positions, respectively.

FIGS. 3A and 3B are isometric and cross-sectional views, respectively, of a preferred embodiment of a contact-sensor module for use with a scanner according to the present invention.

FIG. 4 is a block diagram of a system for calibration and image scanning according to the present invention.

FIGS. 5 depicts a typical selection slip that can be used with a scanner according to the present invention.

FIGS. 6, 7, and 8 depict documents that can be identified via a document identification system according to the present invention

FIGS. 9A-9D depict variable size documents having image areas that can be scanned using the apparatus and methods of to the present invention.

### DETAILED DESCRIPTION OF PREFERRED EMBODIMENTS

General Description

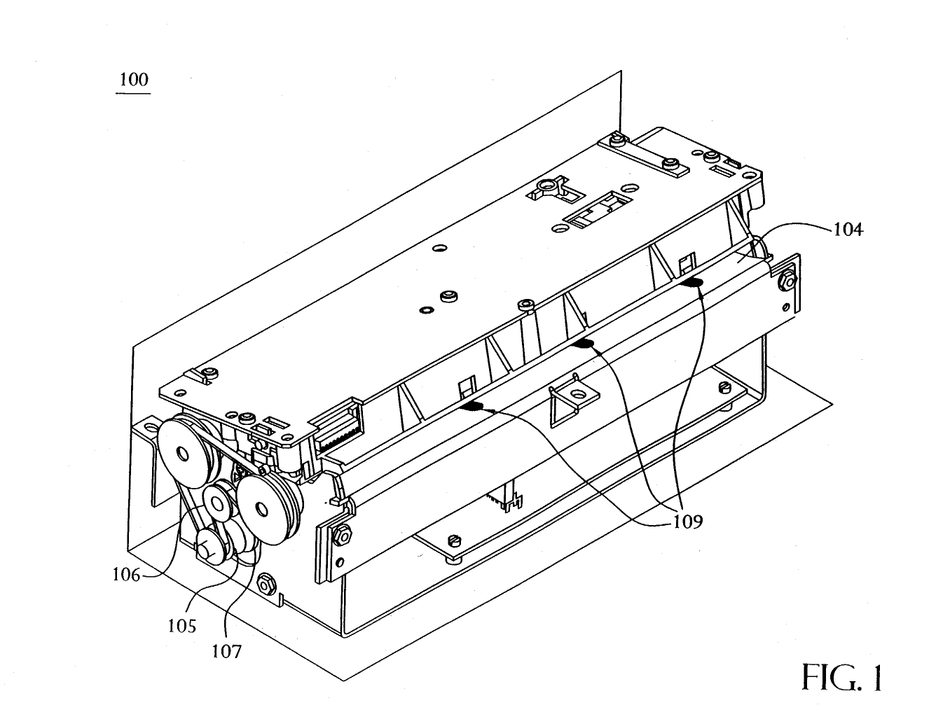

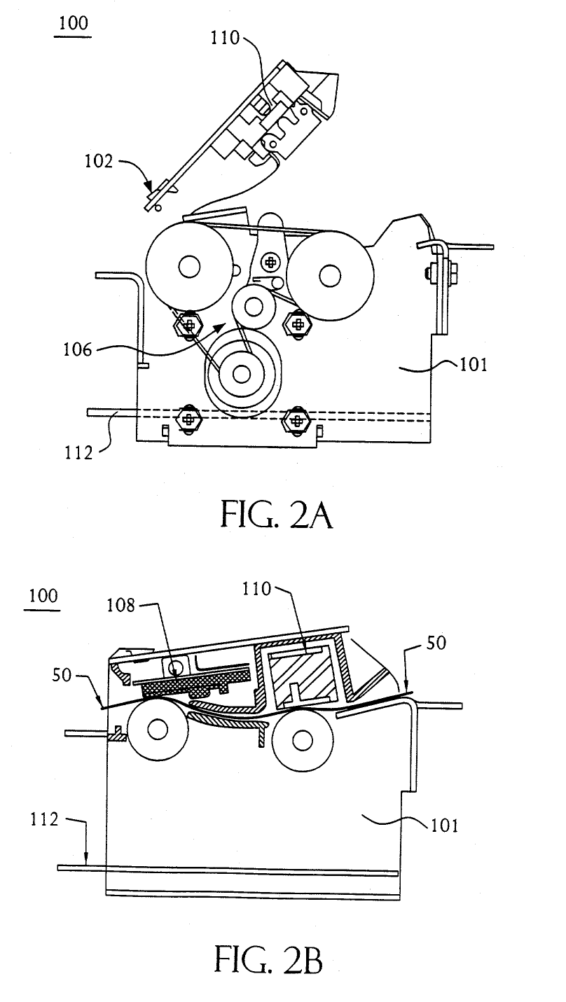

FIG. 1 is an isometric view of a preferred embodiment of a scanner 100 according to the present invention, while FIGS. 2A and 2B are side views of the scanner of FIG. 1 in open and closed positions, respectively. A scanner 100 according to the present invention transports and scans variable sized documents at any orientation, and transmits mark-sense, character, bar-code, and image data extracted from the document to a host processor that interfaces with the scanner.

According to the invention, scanner 100 scans documents 50 to capture signatures and other images at high scan rates (e.g., 200 dots per inch (dpi) for higher resolution, or 100 dpi for quicker transactions, under user command). OMR-type slips, for example, can be scanned for mark-sense data at 100 dpi, while signatures, for example, can be scanned at 200 dpi for greater resolution. Preferably, scanner 100 is micro-controlled, and operates in conjunction with predefined data masks such that all pertinent data fields can be scanned rapidly. The data masks can be downloaded from the host processor via a highspeed parallel interface to minimize data transmission time. Preferably, the host processor is a personal computer (PC), having a microprocessor (such as a Pentium), on which a user application program and scanner operating software are loaded and can be executed.

In a preferred embodiment, scanner 100 is modular and designed to fit as an OEM subassembly into a variety of terminal enclosures. Scanner 100 can be equipped with a hinged, spring-loaded top plate 102 to facilitate cleaning and paper jam removal.

Scanner 100 can transport and scan documents ranging from A4 or letter-size (i.e., 8.5×11 inches), down to documents measuring 3.25 inches wide×3.25 inches long. Although scanner 100 can utilize an edge-guiding input throat 104 to minimize document skew for narrower forms (such as for 3.25 inch forms, for example), such a throat is unnecessary in a scanner according to the invention since smaller forms can be fed in any orientation.

Scanner 100 also includes a feed-through type document transport mechanism 106 with an auto-pick feature. Auto-pick allows a document to be transported and scanned automatically whenever a form is presented at the input. “Pick-on-Command” is basically a lock-out feature that prevents the scanner from accepting a form, except when specifically commanded from the host (e.g., when busy, or when a proper ID or entry code is required to enter documents into the system).

Scanner 100 is equipped with a local controller (i. e., micro-controller (MCU)) board 112. Controller board 112 is mounted in base 101 of scanner 100, and is electrically connected to scan head 110, preferably via a ribbon cable. In a preferred embodiment, scan head 110, which is described in greater detail below, is a linear photodiode sensor array that utilizes 1728 pixels at 200 dpi. Scanning is done reflectively, with an array of LEDs that provide document illumination at a wavelength of 660 nanometers (nm). Preferably, scan head 110 is insensitive to external lighting and EMI interference.

In a preferred embodiment, controller board 112 includes a local controller, such as an 80C196, 16-bit processor system that digitizes the output of scan head 110, for transmission to the host processor. Controller board 112 includes the connectors and driver circuitry for the required interface into the host processor. This includes the flow of information (both incoming commands and outgoing data) over the high-speed, bi-directional parallel port. In addition, the local controller also handles document transport and thermal branding of forms (bet slips and receipts) under command of the host processor. These functions are described in greater detail below.

Documents are transported through scanner 100 via a belt-driven roller system 106, powered by a step motor 107 that can be attached to a pulley 105. Step motor 107 can transport a document with 0.005 inch step increments at 10 inches per second. Thus, images of documents are captured at 200 dpi, both across and along the document, since the scan module sensors are also mounted on 0.005 inch centers. Scanner 100 can scan standard selection slips with or without clock marks.

In a preferred embodiment, the transport speed while scanning is approximately 10 ips at 100 dpi, or 6.5 ips at 200 dpi. Its non-scanning (i.e., slew) transport speed is also approximately 10 ips. The typical transport time for an 8″ long selection slip is, therefore, about 0.8 seconds at 100 dpi. Similarly, the transport time for an 11″ long page is about 1.1 seconds at 100 dpi.

Scanner 100 also preferably includes front document sensors 109 and rear document sensors (not shown) to determine document position. Front document sensors 109 are reflective sensors that sense a form being inserted into the scanner throat. Similarly, the rear document sensors sense a form leaving the scanner. When front sensors 109 detect the insertion of a document into the mechanism's paper inlet, the control processor turns on the step motor to transport the document through the scanner. The control processor also turns on the scan head's light source, and commences line scanning of the form when it reaches the scan line. Documents are scanned at 100 or 200 dpi, based on user command, and image data is transmitted via the high-speed parallel port to the host processor. Processing of the data to extract mark-sense and image data relative to stored data masks takes place in the host processor. At the conclusion of scanning, the back edge of the form is sensed by the rear paper sensors and scanning ceases. Forms are then normally exited out of the rear of the mechanism, and the light source is turned off.

Scanner 100 can also include an optional thermal document brand head 108 that can be used to print (i.e., brand) information on forms. The host downloads print information via the high-speed parallel port. Preferably, information for brand head 108 is controlled by scanner operating software in the host processor, while printing is controlled by the local controller. Preferably, brand head 108 is located at the rear of the scanner mechanism. A solenoid actuator lowers the brand head into contact with the form during printing.

For the branding operation, all information from the host is passed to the scanner operating software as bitmap data. Preferably, all text and images are formatted by the user application software and passed to the scanner operating software. The image is set up as a row/column structure, where a row is defined as one print line having 64 dots, and the columns are defined as the number of rows that make up the print area.

The brander image file is a standard “WINDOWS” .bmp file. The format of such a file includes a “File Header,” followed by a “Bitmap Header,” a “Color Palette,” and the image data to be branded. Once the data is passed to the scanner operating software in the PC, it can be reformatted and sent to the scanner mechanism for branding on the document.

The bitmap image data includes a plurality of 64 bit (8 byte) rows, by a plurality of X columns. In other words, each print line is a row, and a number, X, rows make up the entire printed image. The most significant bit (MSB) of the first byte of each row is the leftmost dot on the print head, and the least significant bit (LSB) of the eighth byte is the rightmost dot on the print head. If a print dot is to be turned on, then the appropriate bit is set to a value of 1; otherwise, the bit is cleared to a value of 0. The number of columns, which represents the maximum print area at the end of the document, can be limited based on the scan density (e.g., 125 columns for 100 dpi; 250 columns for 200 dpi).

Scan Head

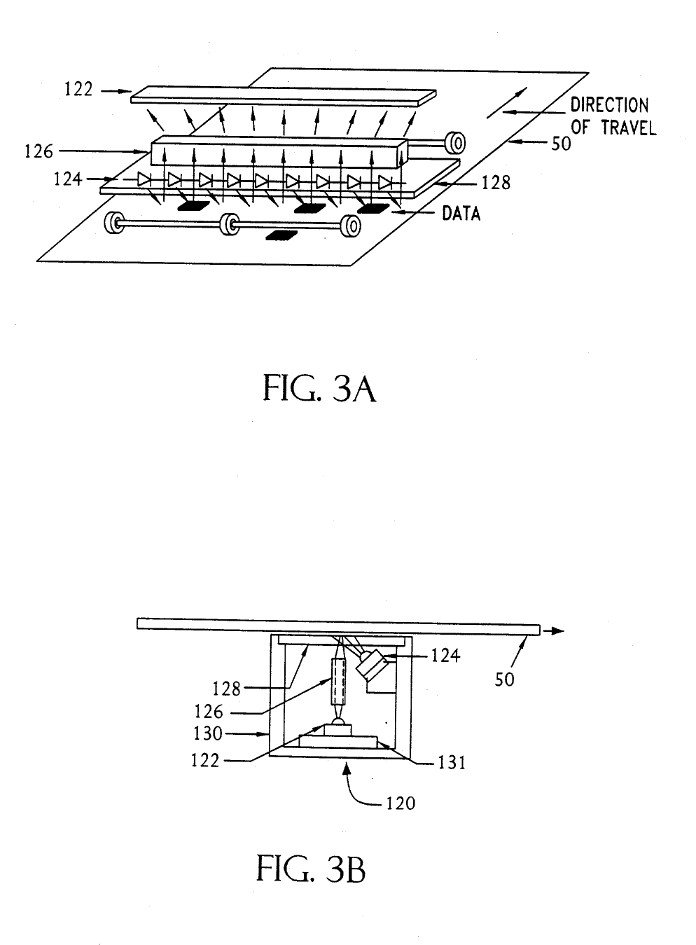

Preferably, scanner 100 includes a commercially available contact-sensor module as its scan head. FIGS. 3A and 3B are isometric and cross-sectional views, respectively, of a preferred embodiment of a contact-sensor module 120 for use with scanner 100. Contact sensor module 120 includes a photodiode linear array 122, illuminated by a solid state LED light source 124. It also contains a gradient-index focusing lens 126 that focuses the image from the surface of a document 50 onto the photosensors of linear array 122. The focus point of gradient index lens 126 is located at the surface of array cover glass 128, such that a line image of the surface of document 50 on cover glass 128 is focused onto photosensor array 122. Light source 124 (located within contact sensor module 120, to a side of photosensor array 122) illuminates document 50, and eliminates any shadow effects of document folds and creases (which can be misinterpreted as data marks). A more detailed description of apparatus and methods for eliminating shadow effects is provided in co-pending U.S. patent application Ser. No. 09/300,989, the contents of which are hereby incorporated by reference.

The scan head components are housed in a housing 130, which can be a rectangular channel that is mounted across the width of the paper path of the mechanism. Housing 130 contains photosensor array 122, which, preferably, has 60 LED chips mounted in a linear array, and gradient index lens 126, which extends the length of the paper width that focuses the line image onto each of 1728 photosensors mounted in a straight line on 0.005 inch centers.

Calibration

Preferably, scanner 100 uses a microprocessor adjustable threshold whereby it automatically determines the black/white (mark/space) switching level for the pixels of photosensor array 122. The threshold level for each pixel is adjusted by the local controller, over the length of the array in 0.00492 inch (8 dots per mm) increments. In this manner, the local controller adjusts the switching threshold for the entire array to compensate for non-uniformity of illumination, as well as for any local variations in array sensitivity.

This procedure is accomplished through a calibration process that is performed to compensate both for non-uniformity of illumination, as well as for any local variations in photosensor sensitivity. During calibration, a standard color plaque (preferably, PDI Part No. 194-6891-1) is used to set the threshold values of all pixels. The calibration plaque has a specific reflective characteristic at pre-determined light wavelengths. The preferred calibration plaque has been selected for its reflective characteristics, and it should be understood that substitution of a different plaque, or one with a different color or reflectivity, can change the sensitivity of the reader in an undesirable or unpredictable manner. Once the unit is calibrated, the threshold switching values for each pixel are stored in non-volatile (e.g., flash) memory for use in subsequent document scanning.

To initiate scanner calibration, the host processor sends a calibration command to the scanner. On receipt of the calibration command, the scanner waits for a calibration document to be inserted into the paper inlet (throat). When a calibration document is inserted and covers the front sensors, the scanner delays for 1.5 seconds to allow the document to seat against the transport rollers. The document is then transported beneath the scan line. The scanner scans the calibration document, and then advances the document approximately 1/3 inch. The scanner scans and advances the calibration document a total of three times.

Calibration calculations are performed on the three scans, to average the switching level for each pixel (based on the reflectivity of the calibration document). When completed, the document is ejected out the back of the scanner. If calibration is “good,” a “#10” byte is returned to the user application program, and the new calibration values are saved for subsequent scans. If the calibration fails, then an error code is returned. Additional details of the calibration process are provided in co-pending U.S. patent application Ser. No. 09/300,989.

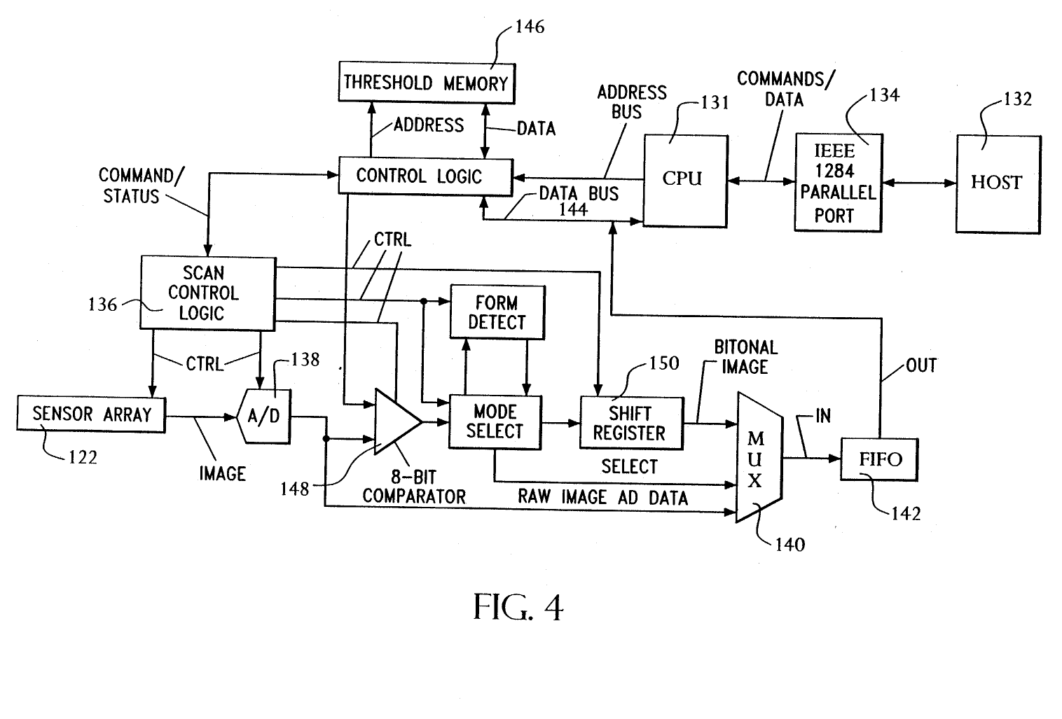

FIG. 4 is a block diagram of a system for calibration and image scanning according to the present invention. Controller 131 receives and decodes all commands from host processor 132 through a parallel port 134. Preferably, parallel port 134 is a high-speed, parallel, bidirectional ECP printer port. A preferred embodiment of host processor 132 is a personal computer (PC) that utilizes a Windows Operating System with a scanner command module (e.g., Pentium processor) running at 133 MHz minimum clock rate, and includes at least 16 MB of random access memory (RAM), and an ECP bi-directional parallel port. The scanner command module receives commands from the user application program. These commands are described in Appendix A. Preferably, scanner 100 interfaces with host processor 132 through two interface connectors which are defined as follows: J1, the main data transfer interface, is a high-speed, parallel, bidirectional interface, and J5 is the power input connector from the PC to the scanner module. The pin connections for a preferred embodiment are provided in Appendix B. The thermal print head and the motor are driven directly by the scanner module under command from the host.

A decoded calibration command, when received from host processor 132, is relayed to scan control logic 136, which handles the calibration procedure. Scan control logic 136 places scanner 100 in a mode to process raw image data directly from A/D converter 138. Each 8-bit digital data byte (per pixel, from A/D converter 138) represents the output of that pixel for the reflectivity of the calibration plaque, which, in turn, represents the black/white switching point (i.e., the gray switching level) of that pixel. This 8-bit pixel data is passed through a multiplexer 140 and FIFO 142 onto a data bus 144, to threshold memory 146, for storage. The process is repeated for three line scans of the calibration plaque. Controller 131 then averages the three scans (for each pixel) to determine an average switching threshold for that pixel. This value is stored in threshold memory 146 to be made available for bitonal (i.e., black/white) image scanning of subsequent documents.

It should be understood that scanner sensitivity can be adjusted by using alternative calibration plaques that can be printed with inks having different reflectance percentages. In addition, controller 131 can also affect scanner sensitivity by virtue of the way it combines multiple pixels into data bits. In combining two pixels into a single bit, controller 131 can specify that both pixels must be dark to consider the output bit dark, or that the resultant bit be dark if only one of the two pixels is dark. Both the pixel size and memory requirements are affected using this technique. In addition, this combinational method also affects the scanner threshold. Scanning a mark with the requirement that both contiguous pixels exceed the dark threshold requires a somewhat darker mark than determining that only 1 of the 2 pixels exceeds the threshold. Controller 131, therefore, affects the sensitivity of scanner 100 by biasing scanner 100 in favor of either faint or bold marks.

Scanning Documents

As described above, threshold values (black/white switching values) for each pixel are stored in threshold memory 146 on local controller board 112. Local controller (CPU) 130 can reference these values, even after scanner 100 has been turned on after a period of non-use. After a calibration procedure, subsequent documents are scanned for black/white pixel content using the stored threshold switching values as reference. Document scanning can be understood by referring to the block diagram of FIG. 4.

As a document to be scanned is transported beneath scan head 110, light incident on its surface is absorbed by dark marks and reflected by the lighter spaces between marks. Photosensor array 122 includes 1728 light sensitive elements, or pixels, arrayed in a line. Each pixel is focused onto an adjacent 0.005″ area of the document's surface (200 dpi). All 1728 pixels of the array (across the 8½ inch scan width) are scanned for each sample (0.005 inch movement) of the document. These light amplitude samples, representing a “picture slice” of the document, are sequentially clocked (at 2 MHZ) through A/D converter 138. The A/D output produces an 8-bit byte per pixel. Each byte defines the signal amplitude of the pixel, representing the reflectivity of the document at that focused pixel area.

The output of A/D converter 138 is coupled to an 8-bit comparator 148, which compares this pixel value against the corresponding 8-bit pixel threshold value stored in threshold memory 146. The output of comparator 148 is a single black/white bit (per pixel). The black/white bit has a value based on whether the scanned value is below or above the stored threshold value (e.g., the bit value is set to 1 if the scanned value exceeds the stored threshold value). The resulting comparator bits are grouped into 8-bit bytes in a shift register 150, and then fed through FIFO 142 onto data bus 144. Controller 131 then formats the data, in accordance with predefined protocol requirements described in Appendix C, and transmits the formatted data to host processor 132 via hi-speed parallel port 134.

A full line scan at 200 dpi (1728 bits per line scan) occupies 216 bytes of memory. Therefore, an 11 inch long document can produce more than 3.8 million pixel samples (bits). Typically, to process and send this amount of data (even at high transmission rates) takes several seconds. For more rapid data processing, and for requirements permitting lower resolution, scanner 100 can combine multiple pixels into single black/white decisions or bits. The number of pixels/bit can be set by host command, and depends on whether mark-sense or signature data is required. For mark-sense data, scanner 100 preferably combines 2 or 4 pixels into a single black/white bit, yielding resolutions of 0.010 or 0.020 inches. For image scanning (signature capture), scanner 100 preferably uses 1 or 2 pixels per bit (0.005″ resolution at 200 dpi, or 0.010″ resolution at 100 dpi) for greater detail. The resolution can be set by external command at 200, 100, or 50 dpi. Image capture at reduced resolutions occupies commensurately less memory, and requires less data transmission time. Scanner 100 can also utilize image compression algorithms, to further reduce transmission time.

Data Processing

Data transmitted from scanner 100 to host processor 132 is configured as a bitmap image, under predefined system protocol. All data processing is done in host processor 132 through specific software function calls, which, as part of the scanner software package, can be loaded into and resident in host processor 132 as scanner operating software. Preferably, host processor 132 operates in a “WINDOWS” environment. The scanner operating software, resident in host 132, comprises a library of functions, known as a dynamic link library (DLL). The DLL is available to the user application, and handles both communication and data processing.

This software receives several different types of data from the scanner hardware module. It can be plain text messages that deal with the scanner's current status (e.g., dpi selected, calibration status, etc.), or bitmap data. Data processing on host 132 is flexible, and can be easily specified using a separate program that is compatible with scanner 100. This program generates an .sdf file (i.e., a file in “simple document format”) that includes all of the parameters and masks needed to scan a particular form.

Preferably, each .sdf file can include up to 64 form definitions, and each form has a unique ID in the .sdf file. That ID is then printed on the form to process itself. The parameters of a form in the .sdf file can include its dimensions (e.g., length, width), the number of areas to decode (e.g., up to 16), and the type and location of each area on the form (e.g., image area, mark-sense area, no clock area, bar-code area). The parameters of this .sdf file are available to the scanner's data processing software, residing in host processor 132, to decode each form in a unique way.

Image/Signature Scanning

Scanner 100 scans each form presented as either a 100 or 200 dpi image (determined by host command). The data are then transmitted via parallel port 134 to host processor 132 as a compressed bitmap image at the commanded density. If a particular area of the document has been identified as an image area, then the data is retained as an image, to be made available to the applications software in host processor 132 via a function call. The applications software can then present the image to the user via a human-machine interface (HMI). If the area has been identified as an alternative data area (mark-sense, BCR, or OCR), the image data is decoded by the scanner software in host processor 132, and the decoded data is made available to the applications software for presentation to the user.

Mark-sense Data Scanning

Mark-sense forms are used extensively for selection slips in lottery applications, for test scoring, voting, and menu selection processes. Scanner 100 scans mark-sense documents in the same manner as any other form. That is, a bitmap image of the form (i. e., a bitonal image at 200 or 100 dpi) is transmitted over parallel port 134 to host processor 132. Scanner operating software in host processor 132 then determines the type of form being read (by utilization of the mark-sense ID code on the form). The software then determines the number and type of the various data areas on the form, by matching the ID code to a previously generated .sdf parameter file located in memory in host processor 132. The parameter file identifies the size and location of data areas on the form, as well as specifics of these data areas (such as data box grid, box size, spacing, location, etc.). In this manner, the data processing software in host processor 132 can determine the number and location of marks (i.e., row/column data) in the data field, and present the data to the host application via function calls.

The scanner software in host processor 132 also uses a weighting technique to determine the percentage of dark to white pixels contained in a data box. The scanner software determines whether the box is marked based on the percentage of black to white bits contained in the data box. The percentage used in this determination is based on a sensitivity parameter that is set in the .sdf file. As a result, the scanner can make use of algorithms to weight dark pixels in the center of the box more heavily than dark pixels on the box's periphery, and to weight contiguous dark pixels more heavily than isolated ones (i. e., noise).

At the conclusion of scanning a ticket for valid data, the scanner's decoding software “knows” the location of all marked data boxes on the form. The row and column locations of the marked data boxes are then made available through function calls to host processor 132. In addition, scanner 100 has the image of the mark in memory, such that look-up tables can be used to differentiate between different kinds of marks (X vs. O, Y vs. N, + vs. −, etc.).

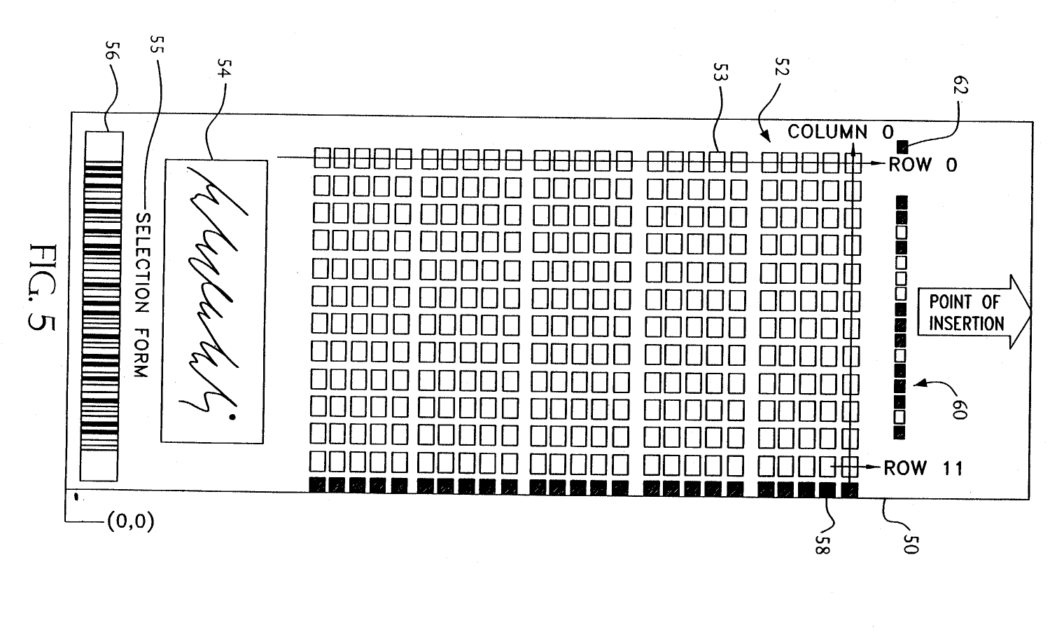

Preferably, scanner 100 defaults to reading selection slips (i.e., bet tickets and receipt coupons) with timing marks (see FIG. 5). In this mode, scanner 100 reports data for only marked data boxes. Scanner 100 specifies the number of data locations marked, transmitting two bytes for each marked box. These bytes define the row/column coordinates in which the data mark was detected.

BCR and OCR Scanning

The scanner software, which resides in host processor 132, also incorporates libraries for both bar code recognition (BCR) and optical character recognition (OCR) applications. These library software functions are called by the scanner software whenever the ID document identifies an area that includes pre-specified bar-code or printed character data. All major types of 1-D bar-codes are decoded, as well as PDF417 (2-D). Scanner 100 can also decode various OCR fonts. This includes various machine-print fonts, as well as OCR-A, OCR-B, and MICR (E13B). The scanner software will search the bitmap image for the specified areas, decode the bar-code data, or the OCR font, convert the data to its equivalent ASCII string, and make the ASCII data available to the host application for presentation to the user.

Deskviewing and Image Rotation

Scanner 100 can transport and scan documents of various sizes. This includes documents as small as 3.25 inches×3.25 inches, up to full-page (8.50 inches×11.0 inches, or A4) documents. According to the present invention, the smaller forms can be inserted into the mechanism in any orientation, and at any angle. Based on the standard location of the ID marks, scanner 100, via scanner software that is resident in the host PC, can de-skew and re-orient the image of the form, such that it is presented in the proper orientation in the bitmap image (to be presented to the user via the host processor's HMI). Mark-sense (row/column) information can also be properly decoded relative to the reference corner of the mark-sense area. This is also the case for bar-code and OCR data, which is presented as a decoded ASCII string.

A method according to the present invention for deskewing an image of a document will now be described. The inventive method has been developed to address several problems resultant from the fact that the bitmap image will not, in general, be perfectly rectangular. For example, a page might be missing any or all of its four comers due to folds; the document itself may not be rectangular in shape; a page might be torn or creased at any point on any edge; dirt in the scanner might generate noise; etc.

To deskew the image, it is desirable to determine the location of the top left comer of the page, as well as the orientation of the page. In general, the process includes building an envelope of the image of the document from the bitmap, removing any irregularities that might exist in the envelope, determining the smallest rectangle that will circumscribe the envelope, adjusting the size and position of the rectangle to best fit the original bitmap image, and then determining a skew angle of the document relative to the bitmap.

Preferably, the process begins with finding the left and right edges of the page, although it should be understood that the same technique could be used to find the top and bottom of the page. First, an integer variable, pixelsinline, is defined to represent the number of pixels in a single scan line. Preferably, pixelsinline is initialized to a value of 10. For each scan line in the bitmap, the left edge is defined as the first of a sequence of pixelsinline consecutive white pixels, and the right edge is defined as the last pixel of the last sequence of pixelsinline consecutive white pixels. (For purposes of this description, it is assumed that the page is white on a black background.) Thus, this process results in two lists of numbers. For each line number, the left edge and the right edge can range from 0 to the last pixel in the scan line. It should be understood that the either the left edge or the right edge or both could also be invalid (since it is possible that a line will have no left edge, no right edge, or neither).

The second step includes reviewing the valid edge points so that only those points defining an envelope of the document are kept. Through the use of triangularization techniques, each point is analyzed to determine whether it is a point on the envelope, or whether it is an “interior” point (i.e., a point in the interior of the envelope). Interior points are discarded. Thus, this process results in a list of points that define the contour of the page.

The third step is to determine the smallest rectangle into which the envelope can be inscribed (this assumes that the document is a rectangle, although it should be understood that the algorithm can be generalized to any shape document). The intersection of this rectangle with the original bitmap is then computed. This results in a rectangle that best fits the document in the original bitmap coordinates (i.e., the final rectangle should not have any edge smaller or larger than the edges of the overall document image). This accounts for irregularities such as, for example, a fold that extends beyond an edge of the document.

At this point, it is straightforward to determine the location of the top left corner of the page and to compute the skew angle. A translation and rotation of the bitmap then are performed to orient the document relative to the top left corner of the bitmap.

Overview of Typical Documents

FIG. 5 shows an exemplary document 50, such as a lottery selection form that can be scanned using the apparatus and methods of the present invention. Document 50 can include a mark sense data field 52, an image data field 54, a character data field 55, and a bar code data field 56. Although document 50 as shown includes one of each type of data field 52, 54, 55, 56, document 50 can include up to 16 such data fields in any combination.

Mark sense data field 52 includes a plurality of data boxes 53, typically aligned in row-column format. As shown, mark sense data field 52 has twelve data rows across the width (i.e., the narrow dimension) of document 50, although the standard (i.e., default) selection form has 14 data rows on 5.0 mm (0.197″) centers, or 12 data rows on 0.25 inch centers, across the width (i.e., the narrow dimension) of the slip. Typically, 12-row forms have data rows on 6.35 mm (0.25″) centers. Mark sense data field 52 also has 25 data columns along the length (i.e., the long dimension) of document 50.

Typically, lottery forms have a clock mark 58 associated with each data column. In older lottery readers, these clock marks were used to synchronize and determine the data box limits for each column. In an aspect of the present invention, clock marks are no longer necessary because of the scanner's deskewing and re-orientation capabilities, its use of data masks, and its stepping and scanning accuracy. As these older forms are still in use in some jurisdictions, a scanner according to the invention also preferably accommodates them.

Image data field 54 can include an image such as, for example, a signature. Typically, image data field 54 has a long dimension and a narrow dimension, where the long dimension of image data field 54 can be perpendicular to the long dimension of document 50 as shown, or parallel thereto. Character data filed 55 includes printed character data that can be interpreted by well known optical character recognition (OCR) techniques. Bar code data field 56 can include either a one-dimensional bar code symbol as shown, or a two-dimensional bar code symbol, that can be interpreted by well known bar code recognition (BCR) techniques. Either OCR or BCR data fields can have their long dimensions either parallel or perpendicular to the long dimension of the form.

A scanner according to the present invention can scan and read standard letter-size (i.e., 8.5″×11.0″) pages interchangeably with A4 (i.e., 210 mm×297 mm) size pages. The scanner can also scan smaller documents (e.g., A5 and A6), on down to 3.25″ wide slips. Preferably, the scanner scans documents in reflective mode. Thus, to optimize performance, certain paper stocks, printing inks, and dimensional specifications are preferred.

For example, it is preferred that all paper stock have a minimum reflectance of 80% as measured using a Moore Model 082 tester, or equivalent thereof, with a barium sulfate plaque as standard for 100% reflectance. Measurements should be taken in the near infra-red region.

Preferred paper stock dimensions for selection slips are no less than about 82.55 mm+/−0.12 mm (3.25″+/−0.005″) in width, and can range from 82.55 mm (3.25″) to 228.6 mm (9.0″) in length. Full pages documents are preferably no more than 215.9 mm+/−0.12 mm in width, and no more than 297 mm+/−0.12 mm (11.7″+/−0.005″) in length. Preferably, all paper stock has a nominal thickness of about 0.114 mm (0.0045″), with a minimum thickness of about 0.100 mm (0.0039″), and a maximum thickness of about 0.200 mm (0.0079″).

Preferably, background printing on a form has a print contrast signal (PCS) of less than 0.10, referenced to an unprinted section of the form. PCS is a measure of the difference in reflectance between a mark and the paper on which it is printed. Specifically, PCS=(Rp−Rm)/Rp, where Rp is the paper reflectance, and Rm is the mark reflectance. Preferred PCS values specified herein are obtained using the Moore Model 082 tester equipped with a visible light filter operating in the bandpass range of 600-700 nanometers. A list of preferred background printing colors/inks is provided in Appendix D.

The scanner processes selection slips with clock marks as a default. Clock marks can be located at either the right or left edge of the slip (along the slip's length/long dimension). Data marks located either between clocks, or concurrent with clock marks (i.e., on-clock mode) can also be processed. Clock marks can be printed using black, green, or blue inks. Preferably, clock marks should provide a PCS value of greater than 0.65, have sharp edges, be of uniform intensity, and be free of ink smudges and specks in areas between clock marks. In overprinting clock mark patterns (i.e., black clock marks coupled with red data boxes), the lengthwise registration of the clock mark pattern should be maintained within +/−0.00791 (0.2 mm) relative to the data box position.

As the data box areas of the form are preferably scanned using red light, data box outlines should be printed with background (i.e., reflective) ink. Data box outlines and corresponding background numbers are used to indicate the placement of hand marked data. Standard (i.e., default) data box dimensions are given in Appendix E.

Hand marking can be done with any medium that is sufficiently dark and non-reflective (using red light). Marks should be clear, legible, and exhibit a minimum PCS of 0.65. It should be understood that a standard #2 pencil gives reflectance readings of about 3% (i.e., PCS>0.90), and is ideal for marking forms because of both availability and ease with which mistakes can be corrected. Most blue, black, and green ball point pens and markers also meet necessary reflectance requirements and can be used to mark the tickets. A list of pens and pencils, which are preferred for use in marking tickets, is found in Appendix F, and is useful to indicate the scope of writing instruments which may be used.

When marking tickets, it is unnecessary to scrub over a mark, to make it appear big and dark. The clarity and positioning of the mark is more important than the apparent intensity. For example, if a mark is placed outside a marking area, it should be completely erased and placed in the proper location, rather than widening the mark until it extends into the proper area.

The scanner uses high resolution image optics so that marks can be made in a variety of shapes and sizes, provided that the lines do not extend between data boxes, exhibit a PCS value of greater than 0.65, and have a stroke width greater than 0.012″ (0.305 mm). A single stroke, for example, can be positioned anywhere within the data box, with an axis parallel to the long axis of the data box. Dots, circles, or X's can be positioned anywhere within the data box.

Mark sensitivity can be set in a parameter file as the diameter of the smallest circle to be read by the scanner. This sensitivity can be made to comply with certain rules for mark sizes. For example, a single stroke can be required to have a length greater than ⅔ the length of the box, with its axis parallel to the long axis of data box, or a length greater than ⅔ the diagonal length of the box, with its axis diagonal across selection box. A filled circle (or dot) can be required to have an area greater than ¼ of the selection box area, while a hollow circle can be made to have a diameter greater than ¾ of the selection box width for example. It can be required that the selection box be fully shaded. An ‘X’ can be permitted, for example, with each arm of the ‘X’ being no greater than the diagonal length of the selection box and aligned towards the box corners.

Preferably, the scanner also processes pre-printed forms printed with ink or by thermal methods. Pre-printed forms should have data marks which adhere to the same reflectance, PCS, dimensional, and spacing requirements as selection slips. Pre-printed forms (e.g., receipts) must be aligned on the same row-centers as selection slips. According to one aspect of the invention, control software residing in a host processor that interfaces with the scanner can be customized to handle unique forms and requirements.

Document Identification System

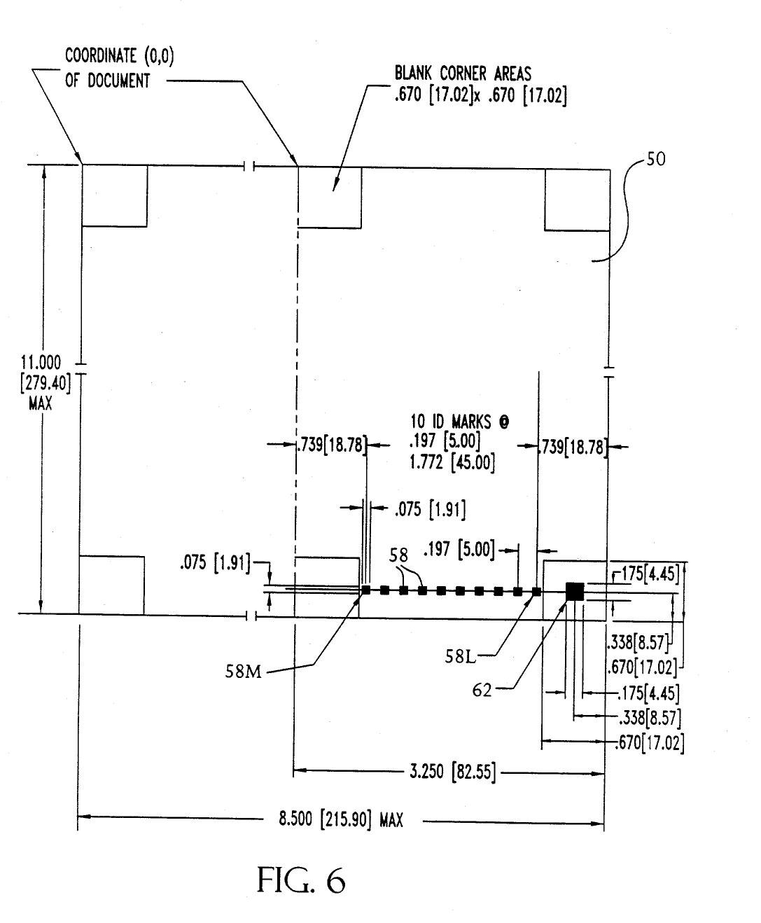

FIG. 6 provides a reference for the following description of a document identification system according to the present invention. This concept creates a unique mark, called the ID clock/rotation indicator 62. ID clock/rotation indicator 62 is used both for determining the orientation at which a document is scanned into the reader, and also as the clock mark for ID marks 58. The minimum size document that can be scanned (i.e., 3.25 inches by 3.25 inches) is based on the necessary size of ID marks 58 and ID clock 62.

A first purpose of ID clock/rotation indicator 62 is to define the lower right-hand corner of document 50. Indicator 62 is used to determine the orientation of document 50 as it is fed into scanner 100. Once the orientation is determined, the document image is de-skewed and rotated so the (0,0) coordinate, or origin, is positioned as shown in FIG. 6. The origin is, by definition, the upper left-hand corner of document 50 as it is fed into scanner 100. Preferably, rotation indicator 62 is the only mark in the corner of document 50. This area is outlined around rotation indicator 62 in the lower right corner of the documents shown in FIG. 6. To facilitate the scanner's identification of rotation indicator 62, it is preferred that all other corners of document 50 be blank. These areas are also outlined in FIG. 6.

Another use of ID clock/rotation indicator 62 is to decode the document ID, defined by ID marks 58, 10 of which are pictured in FIG. 6. Preferably, ID marks 58 are on the same centerline as ID clock 62, and conform to specifications for 5 mm mark sense data. As shown in FIG. 6, ID marks 58 represent a 10-bit binary code, with the mark closest to ID clock 62 being the least significant bit 58L. The most significant bit 58M (i.e., the mark farthest from the ID clock) is always set. That most significant bit 58M is set indicates that document 50 has an ID code associated with it. If there are no ID marks 58 on document 50, or if there is no ID clock/rotation indicator 62, then document 50 is considered to have an ID code of zero. With an ID code of zero, the scanner reverts to the default document parameters. This results in a total of 511 unique document ID codes, starting with 200H (512) and ending with 3FFH (1023).

The document ID is used to locate the document parameters in a file created for decoding mark-sense and image data on the document. Preferably, two files are used for this purpose. The first file includes the name and location of the parameter file to be used to decode the data areas on the document. The second file includes certain parameters that define and describe the document (e.g., length, width, etc.). A full description of file parameters is provided in Appendix G.

After all of the areas on the document are decoded and/or imaged the information will be passed on to the user application program via a predefined message structure. Mark-sense data, for example, is reported in row and column format. Additional message information can include, for example, the type of ticket data, the document ID (which will be sent before any document data), and the “area number” (which defines a particular area to which the data corresponds).

For each document processed, the following typical message is returned:

<Type of Data>/<Document ID LSB>/<Document ID MSB>/<Area Number>/<Optional byte(s) for number of columns>/<Optional byte(s) for number of rows>/<Data for Area 1>

<Type of Data>/<Document ID LSB>/<Document ID MSB>/<Area Number>/<Optional byte(s) for number of columns>/<Optional byte(s) for number of rows>/<Data for Area 2>< . . . >

where:

<Type of Data>=‘T’ for Ticket, ‘R’ for Receipt (Row/Col data), ‘S’ for Image, ‘B’ for Bar Code, “O” for OCR, ‘I’ for Invalid, or ‘U’ for decoded receipt (ASCII string);

<Optional byte(s) for number of columns/rows>=2 bytes if <Type of Data>=‘T’ or ‘R’;

<Data for Area n>=starts with <Number of results LSB>/<Number of results MSB>, if <Type of Data>=‘T’ or ‘R’;

<Data for Area n>=starts with line length (2 bytes), number of lines (2 bytes), if <Type of Data>=‘S’; and

<Data for Area n>=starts with <textlength LSB>/<textlength MSB>, if <Type of Data>=‘O’ or ‘B’.

It is preferred that documents to be scanned conform to the above parameters. In the event that a nonconforming document is scanned, the document ID and area number parameters in the message will be sent as zeros. If no ID/Rotation mark is found, the reader will use an ID value of 0, and use any parameters that have been stored in the parameter file for ID=0. The user, therefore, will readily be able to define a default document format. In the event that the parameter file is missing, the reader can use hard-coded default parameters.

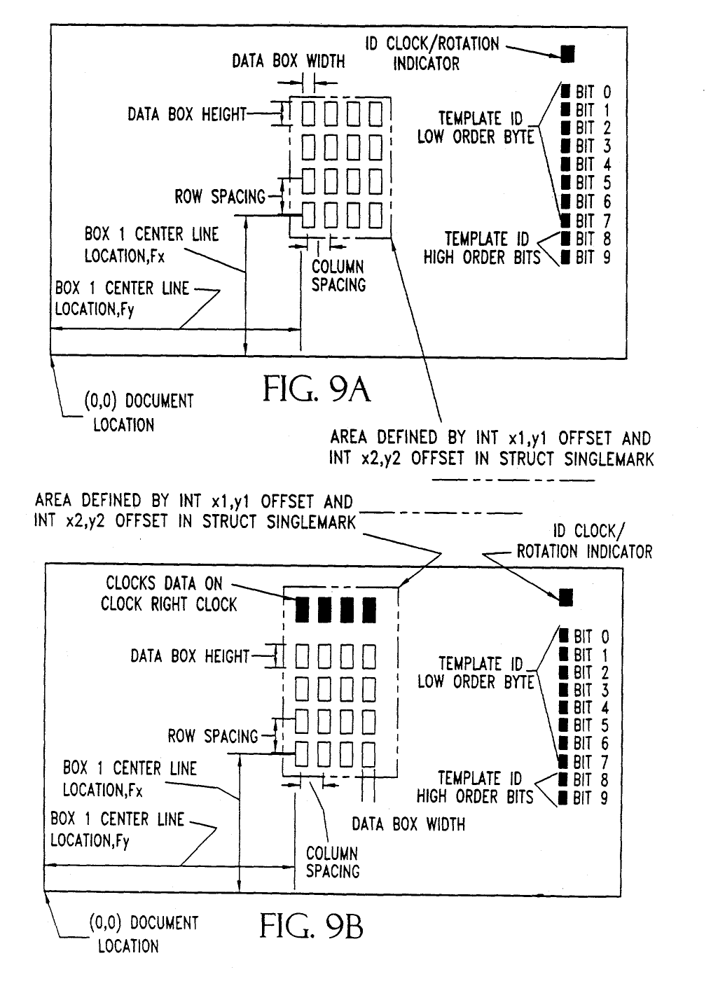

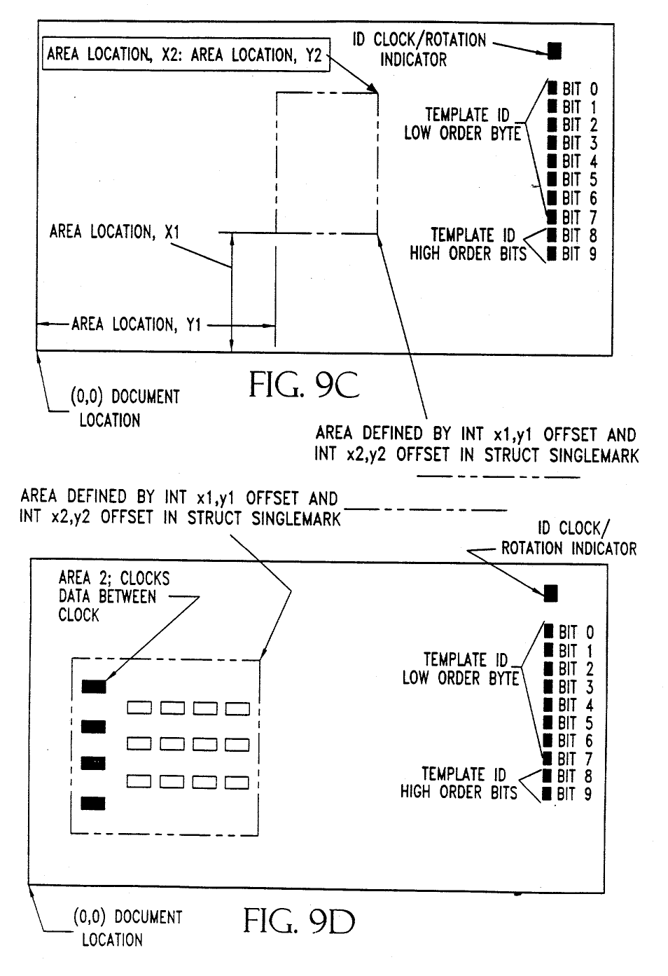

One type of area on a variable size document using a document identification system according to the present invention is a mark-sense area, which does not use clock marks (also called timing marks) (see FIG. 9A). Clock marks are normally used to define the data rows and columns on a document. With no clock marks, there are a number of parameters, which must be defined in order to locate and decode the mark sense boxes in these areas. Individual areas can have different grid and data box parameters, as long as the grid remains the same within any one area.

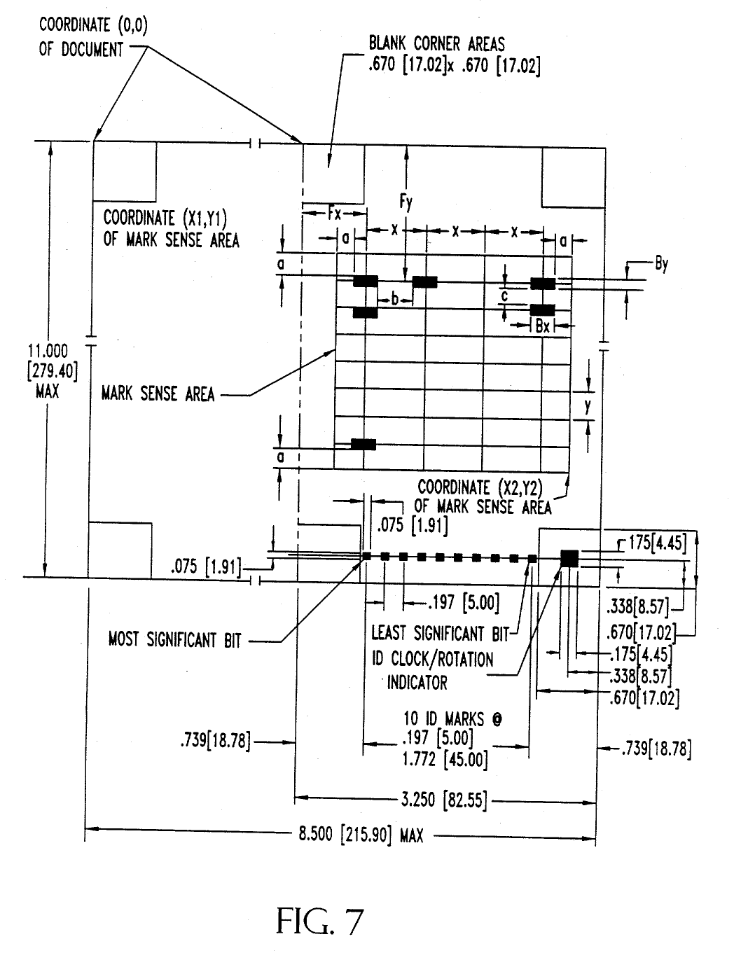

With reference to FIG. 7, the coordinates (X1, Y1) and (X2, Y2) define the total “mark-sense area,” which is shown by a grid area. A plurality of data boxes are contained in the mark sense area and, preferably, are on the defined grid. The minimum size of this mark-sense area would be a single mark-sense box of minimum size. The maximum size could be the entire document minus the blank corner areas and the ID area discussed above with reference to FIG. 6.

The mark-sense grid defines the placement of data boxes within the mark-sense area. All the boxes within a single mark-sense area should be on the same grid and be of the same size. The following are the descriptions of the grid parameters:

‘a’ value=blank area (not visible to scanner). This is the space from the edge of the outside data boxes to the boundary of the mark-sense area. This dimension also indicates the location of the data boxes positioned in the four corners of the mark-sense area. The minimum value for this parameter is 0.2 in. (5.08 mm).

‘x’ value=horizontal data box grid center lines. The data boxes are centered on this spacing throughout the mark-sense area. The minimum value for this parameter is 0.197 in. (5.00 mm).

‘y’ value=vertical data box grid center lines. The data boxes are centered on this spacing throughout the mark-sense area. The minimum value for this parameter is 0.197 in. (5.00 mm).

The data boxes, in the mark-sense area are the only locations where hand marked or preprinted marks should be made. Marks made too far outside of a box boundary may be interpreted as an incorrect mark location.

‘Bx’ value=horizontal data box dimension. All data boxes in the mark-sense area have a width defined by this value. The minimum value for this parameter is 0.0985 in. (2.50 mm).

‘By’ value=vertical data box dimension. All data boxes in the mark-sense area have a height defined by this value. The minimum value for this parameter is 0.0985 in. (2.50 mm).

‘b’ value=horizontal blank space between data boxes dimension. All data boxes in the mark-sense area must be separated by this minimum value. The minimum value for this parameter is 0.0985 in. (2.50 mm).

‘c’ value=vertical blank space between data boxes dimension. All data boxes in the mark-sense area must be separated by this minimum value. The minimum value for this parameter is 0.0985 in. (2.50 mm).

‘Fx’, and ‘Fy’ values=Location of the center of the data box closest to coordinate (0,0) of the document. This is also the intersection of the first horizontal and vertical grid lines in the mark-sense area.

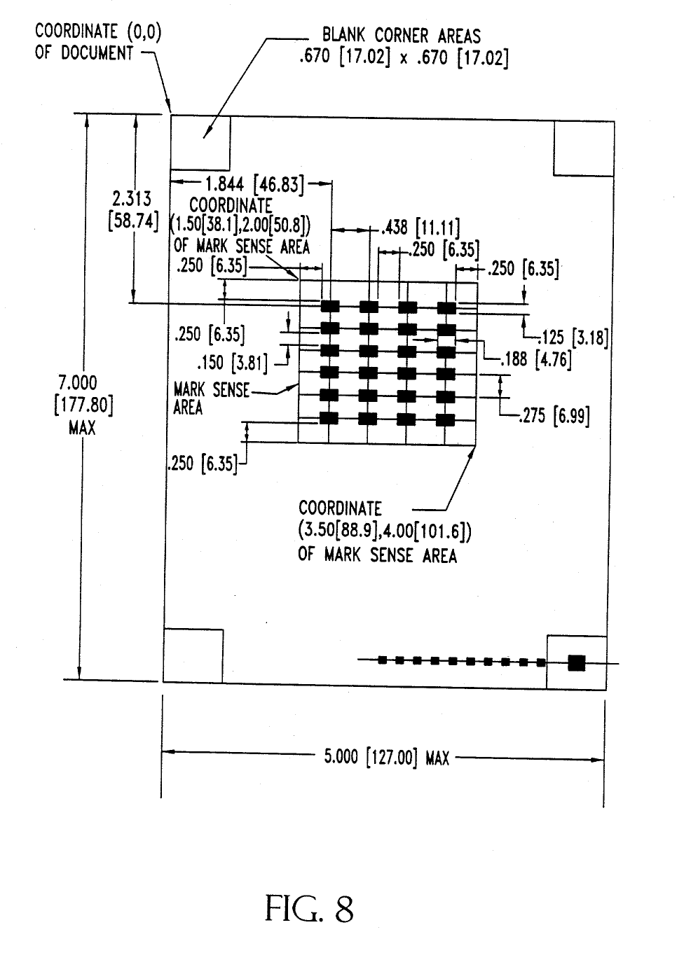

FIG. 8 shows an example of a 5 inch by 7 inch document having one mark-sense area without clock marks defined as follows:

X1=1.5 inches; X2=3.5 inches; Y1=2.0 inches; Y2=4.0 inches;

X=0.4375 inch; y=0.275 inch;

Bx=0.1875 inch; By=0.125 inch; Fx=1.844 inches; Fy=2.31 inches

a=0.25 inch; b=0.25 inch; c=0.15 inch

A second type of mark-sense area on a variable size document using a document identification system according to the present invention does use clocks. The clock marks are normally used to define the columns, consisting of data rows, on a document. The clock marks are said to be either “on” clock or “between” clock. This indicates that the data boxes are either coincident with the clocks (as shown in FIG. 9B) or are located between the clocks (as shown in FIG. 9D). This type of area uses the same data box and grid parameters described above. The clock mark data rows are either parallel (FIG. 9B) or perpendicular (FIG. 9D) to the document ID marks. The document mark-sense areas with clock marks uses all the same parameters as those areas without clock marks.

The image areas on a variable size document also use the inventive document identification system. An image area can be defined using two coordinates (X1, Y1) and (X2, Y2) as shown in FIG. 9C. These coordinates define the upper left-hand and lower right-hand rectangular corners of the image to be returned.

Slip Editor

A scanner according to the present invention can also include a slip editor program that allows a user to easily define a new ticket to be scanned. Preferably, the slip editor is a multi-document application (i.e., several files can be opened simultaneously) that runs in a “WINDOWS” environment or other such operating system such as Linux, for example. The slip editor is used to generate and edit .sdf parameter files. Each .sdf file can include a plurality of different slips, and each slip can include a plurality of data areas. In a preferred embodiment, each .sdf file can include up to 64 different slips and each slip can include up to 16 data areas, though it should be understood that a .sdf file can include any number of slips and each slip can include any number of data areas. Each data area includes one of five predefined data types: bar-code, image, mark-sense (clocks), mark-sense (no clocks), and optical character recognition (OCR).

When the document editor is run, a window appears which includes two windowpanes. One of the windowpanes displays a tree, which allows the user to browse through the slips that have previously been generated. The other windowpane displays the information for the slip currently being processed.

In a preferred embodiment, a slip editor according to the invention includes five menu items that the user can select. A File menu allows the user to open, close, or save a file, or to exit the program. An Edit menu allows the user to create or delete a slip, or to create or delete an area. A View menu provides or suppresses a view of the toolbar. A Window menu allows the user to organize the different windows on the screen. A Help menu provides version information and online help.

To create a new slip, the user provides information on a General Info screen, a Slip Area Info screen, and a Build screen. At the General Info screen, the user enters the slip name, slip ID, slip width, and slip length. The slip name is a freestyle string. The slip ID represents an ID code that has been marked or pre-printed on the ticket, or entered as a decimal integer. The slip editor also provides a way of defining an ID to be read on the document. This ID is preferably a set of marks (mark sense code) on the document, but also can be a bar code or an OCR area. The information decoded by the slip editor generates an integer that is compared to the IDs stored in the .sdf file. The slip editor also provides a way to define a rotation mark. Preferably, the rotation mark includes two square printed marks along one edge of the document. The precise location of the marks with respect to the edges of the document are stored in the .sdf file to allow the scanning apparatus to compensate for badly cut tickets (using a technique known as “triangulation”). Preferably, slip width ranges from 3.25 inches to 8.5 inches, with a slip width of 0 representing a variable slip width. Preferably, slip length ranges from 3.25 to 11 inches, with a slip length of 0 representing a variable slip length.

At the Slip Area Info screen, the user can enter parameters that define the data areas on the slip. For each area, the user can enter the data type included in that area, as well as the location of the area on the slip. The location is specified by top (i.e., the distance from the top edge of the ticket to the top of the area), bottom (i.e., the distance from the top edge of the ticket to the bottom of the area), left (i.e., the horizontal distance from the left edge of the ticket to the left edge of the area), and right (i.e., the horizontal distance form the left edge of the ticket to the right edge of the area).

The Build screen depends on the type of area defined in the Slip Area Info screen. OMR type, for example, is defined as a customer specific OMR type (e.g., 14 data rows on 5 mm spacing with 9 columns of data). No data field is necessary for an image area. A Build screen for mark-sense data can include the following parameters: row spacing (i.e., the horizontal distance between the centers of two data boxes), data box width (i.e., the horizontal dimension of the data box), left channel (i.e., the horizontal width of the left channel, which starts at the left edge of the area), right channel (i.e., the horizontal width of the right channel, which starts at the right edge of the area), number of rows (i.e., the number of boxes, not counting the left or right channels, on a horizontal line), first box (i.e., the horizontal distance from the left edge of the area to the center of the first data box), field sensitivity (i.e., the diameter of the smallest mark to be detected). A Build screen for mark-sense data with clocks can also include clock placement (i.e., right clock or left clock), and clock control (i.e., on clock or between clock). A build screen for OCR data will include parameters that help in optical character recognition (e.g., language, numerics (digits) vs. lower-case or upper-case characters, font, font size, font color, printer type, background color, bold, italics, underlined, etc.).

For consistency, as various slip parameters are entered, the slip editor checks their validity. For example, an area must be large enough to include the number of rows, subject to the row spacing parameters. If these requirements are not met, the slip editor can display a warning message and list all parameters that do not pass the necessary constraints. The slip editor can also have other entry interfaces. For example, parameters to be entered can be automatically extracted from a scanned image of the slip to be defined. The slip editor can also handle a two-sided document, with rotation mark, ID, and data areas on either or both of the front and back of the document.

Thus, there have been described apparatus and methods for scanning and image processing of variable sized documents having variable orientations. Those skilled in the art will appreciate that numerous changes and modifications may be made to the preferred embodiments of the invention and that such changes and modifications may be made without departing from the spirit of the invention. It is therefore intended that the appended claims cover all such equivalent variations as fall within the true spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method for defining a slip to be scanned, the method comprising:
providing a user interface via which slip definition parameters that define a slip to be scanned can be entered;
receiving the slip definition parameters via the user interface; and
storing the received slip definition parameters in a slip definition parameter file.

2. The method of claim 1, wherein receiving the slip definition parameters comprises receiving at least one of a slip name, a slip identification number, a slip width, and a slip length.

3. The method of claim 1, wherein receiving the slip definition parameters comprises receiving a value that indicates that the defined slip can have a variable slip width.

4. The method of claim 3, wherein receiving the slip definition parameters comprises receiving a value that indicates that the defined slip can have a variable slip length.

5. The method of claim 1, wherein receiving the slip definition parameters comprises receiving a data area definition parameter that defines a data area on the slip.

6. The method of claim 5, wherein receiving the data area definition parameter comprises receiving a data type parameter that identifies a data type associated with the data area.

7. The method of claim 6, wherein receiving the data type parameter comprises receiving a value that indicates that the data type is one of bar code data, image data, mark-sense data, and optical character recognition data.

8. The method of claim 7, wherein receiving the data type parameter comprises receiving a value that indicates that the data type is one of mark sense data with clock marks and mark sense data without clock marks.

9. The method of claim 5, wherein receiving the data area definition parameter comprises receiving a data area location parameter that identifies a location of the data area on the slip.

10. The method of claim 1, further comprising:
validating the received slip definition parameters before storing the received slip definition parameters in the slip definition parameter file.

11. The method of claim 1, wherein storing the received slip definition parameters in the slip definition parameter file comprises storing the received slip definition parameters in a .sdf file.

12. The method of claim 5, wherein receiving the slip definition parameters comprises receiving respective data area definition parameters that define each of a plurality of data areas on the slip.

13. The method of claim 12, wherein receiving the slip definition parameters comprises receiving respective data area definition parameters that define up to 16 respective data areas on the slip.

14. The method of claim 12, wherein receiving the respective data area definition parameters comprises receiving a respective data type parameter that identifies a respective data type associated with each of the respective data areas.

15. The method of claim 14, wherein receiving the respective data type parameters comprises receiving a value that indicates that the data type is one of bar code data, image data, mark-sense data, and optical character recognition data.

16. The method of claim 15, wherein receiving the respective data type parameters comprises receiving a value that indicates that the data type is one of mark sense data with clock marks and mark sense data without clock marks.

17. The method of claim 14, wherein receiving the respective data area definition parameters comprises receiving a respective data area location parameter that identifies a respective location of each of the respective data areas on the slip.

18. The method of claim 1, further comprising:
receiving respective slip definition parameters for each of a plurality of slips; and
storing the respective slip definition parameters in the slip definition parameter file.

19. The method of claim 18, further comprising:
receiving respective slip definition parameters for up to 64 slips.

20. A computer-readable medium having stored thereon computer-executable instructions for performing a method comprising:
providing an interface via which slip definition parameters that define a slip to be scanned can be entered;
receiving the slip definition parameters via the user interface; and
storing the received slip definition parameters in a slip definition parameter file.

21. The computer-readable medium of claim 20, having stored thereon computer-executable instructions for providing a user interface via which the slip definition parameters can be manually entered.

22. The computer-readable medium of claim 20, having stored thereon computer-executable instructions for providing a graphical interface that extracts the slip definition parameters from a scanned image of the slip.

23. Apparatus for scanning a slip, the apparatus comprising:
a slip editor that provides a user interface via which slip definition parameters that define a slip to be scanned can be entered, receives the slip definition parameters via the user interface, and stores the received slip definition parameters in a slip definition parameter file; and
scanning means for scanning the slip.

24. Apparatus according to claim 23, wherein the scanning means comprises:
means for extracting a slip identification number from the slip;
means for retrieving from the slip definition parameter file, slip definition parameters associated with the slip identification number; and
means for scanning the slip based on the retrieved slip definition parameters.
